(19) United States
(12) Patent Application Publication
(10) Pub. No.: US 2014/0057665 A1
(43) Pub. Date: Feb. 27, 2014

(54) MOBILE COMMUNICATION TERMINAL WITH DISTANCE AND SPEED SENSING FUNCTION AND SENSING METHOD

(71) Applicant: CHIH-YUAN YANG, Tu-Cheng (TW)

(72) Inventor: CHIH-YUAN YANG, Tu-Cheng (TW)

(21) Appl. No.: 13/662,582

(22) Filed: Oct. 29, 2012

(30) Foreign Application Priority Data
Aug. 22, 2012 (CN) 2012103007111

(51) Int. Cl. H04W 24/00

(52) U.S. Cl. 455/456.6

(57) ABSTRACT

A method for sensing distance between a mobile communication terminal and a target object and speed value of the mobile communication terminal relative to the target object is provided. The method includes receiving an activating signal generated by an input unit, controlling a switching unit to connect an encoding/decoding unit to a wave guide pipe; sending the activating signal to the encoding/decoding unit; generating an encoded electromagnetic wave signal having a specific frequency band according to the activating signal by the encoding/decoding unit; transmitting the encoded electromagnetic wave signals to a target object and receiving the electromagnetic wave signal reflected by the target object by the wave guide pipe; calculating distance value between the mobile communication terminal and the target object and speed value of the mobile communication terminal relative to the target object; and outputting a result of the calculating. The mobile communication terminal is also provided.

### BACKGROUND

1. Technical Field

The present disclosure relates to mobile communication terminals with distance and speed sensing function and sensing methods, and particularly to a mobile communication terminal and a method for sensing distance between the mobile communication terminal and a target object and speed of the mobile communication terminal relative to the target object.

2. Description of Related Art

When driving, a driver needs to keep the vehicle a certain distance from a vehicle in front of him or her. In order to sense the distance from the vehicle in front, the driver often uses his or her experience and common sense to judge speed of the vehicle in front, which is inaccurate.

Therefore, it is desirable to provide a mobile communication terminal and method, which can overcome the above-mentioned shortcomings

### BRIEF DESCRIPTION OF THE DRAWINGS

FIG. 1 is a functional block diagram of a mobile communication terminal with distance and speed sensing function, according to a first embodiment.

FIG. 2 is a functional block diagram of a processing unit of the mobile communication terminal of FIG. 1.

FIG. 3 is a flowchart showing a method for sensing distance between the mobile communication terminal and a target object and speed value of the mobile communication terminal relative to the target object by the mobile communication terminal of FIG. 1.

### DETAILED DESCRIPTION

Embodiments of the disclosure will be described with reference to the accompanying drawings.

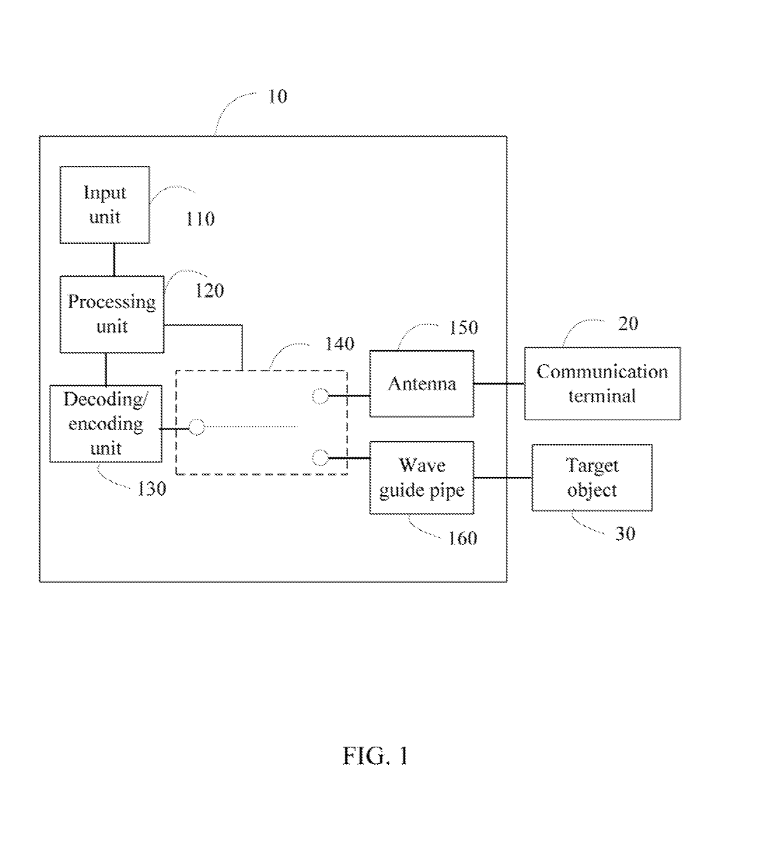

FIG. 1 is a functional block diagram of a mobile communication terminal with distance and speed sensing function. The mobile communication terminal 10 is used in electronic devices with a communication function, such as mobile phone. The mobile communication terminal 10 includes an input unit 110, a processing unit 120, a decoding/encoding unit 130, a switching unit 140, an antenna 150, and a wave guide pipe 160.

The input unit 110 receives inputs from a user, generates an activating signal to the processing unit 104, to activate the distance and speed sensing function.

The switching unit 140 is a double-throw switch. When the processing unit 120 receives the activating signal, the switching unit 140 connects the decoding/encoding unit 130 to the wave guide pipe 160, thus performing the distance and speed sensing function. The switching unit 140 automatically connects the decoding/encoding unit 130 to the antenna 150 when a predetermined time period is expired after receiving the activating signal, such as, 2 seconds.

The decoding/encoding unit 130 encodes signals sent by the processing unit 120, generates encoded electromagnetic wave signals having a specific frequency band, decodes received electromagnetic wave signals having the specific frequency band, and sends the decoded received electromagnetic wave signals to the processing unit 120. The mobile communication terminal 10 has a certain frequency band of 900/1800 or 2400 MHZ.

The antenna 150 transmits the encoded electromagnetic wave signals having the specific frequency band to other communication terminals 20 and receives electromagnetic wave signals having the specific frequency band sent by the other communication terminals 20.

The wave guide pipe 160 transmits the encoded electromagnetic wave signals having the specific frequency band to a target object 30 and receives electromagnetic wave signals having the specific frequency band reflected by the target object 30.

The processing unit 20 controls the switching unit 140 to connect the decoding/encoding unit 130 to the wave guide pipe 160 after receiving the activating signal, and sends the activating signal to the encoding/decoding unit 130. The encoding/decoding unit 130 generates the electromagnetic wave signal having the specific frequency band according to the activating signal. The wave guide pipe 160 transmits the electromagnetic wave signal having the specific frequency band according to the activating signal to the target object 30. The wave guide pipe 160 receives the electromagnetic wave signal reflected by the target object 30. The encoding/decoding unit 130 decodes the received electromagnetic wave signal having the specific frequency band, and sends the decoded received electromagnetic wave signals to the processing unit 120.

The processing unit 20 calculates the distance value between the mobile communication terminal 10 and the target object 30 and speed value of the mobile communication terminal 10 relative to the target object 30, and outputs a result.

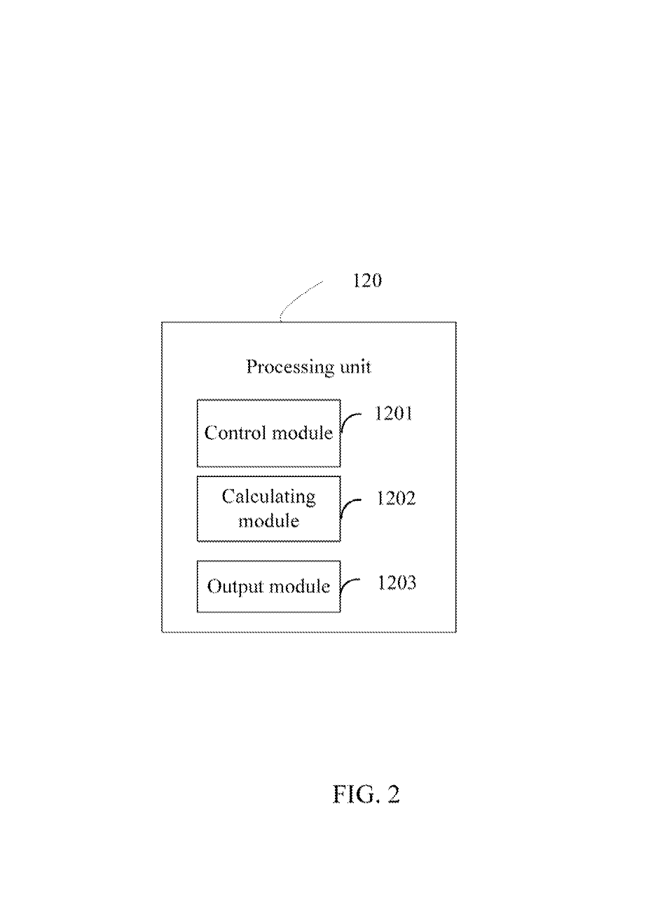

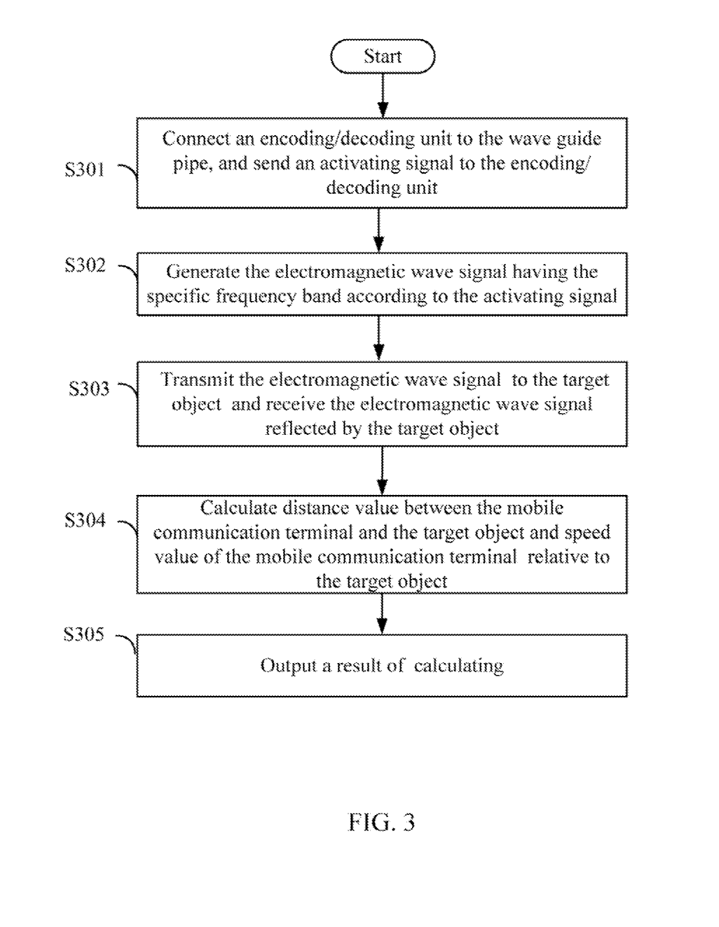

Together with FIG. 2, the processing unit 120 includes a control module 1201, a calculating module 1202 and an output module 1203. Functions of the modules will be described together with FIG. 3.

FIG. 3 is a flowchart showing a method for sensing distance value between the mobile communication terminal and the target object and speed value of the mobile communication terminal relative to the target object by the mobile communication terminal of FIG. 1.

In step S301, the control module 1201 receives the activating signal sent by the input unit 110, controls the switching unit 140 to connect the encoding/decoding unit 130 to the wave guide pipe 160, and sends the activating signal to the encoding/decoding unit 130.

In step S302, the encoding/decoding unit 130 generates the electromagnetic wave signal having the specific frequency band according to the activating signal.

In step S303, the wave guide pipe 160 transmits the electromagnetic wave signal having the specific frequency band according to the activating signal to the target object 30 and receives the electromagnetic wave signal reflected by the target object 30.

In step S304, the calculating module 1202 calculates the distance value between the mobile communication terminal 10 and the target object 30, and speed value of the mobile communication terminal 10 relative to the target object 30. The method of calculating the distance value between the mobile communication terminal 10 and the target object 30, and speed value of the mobile communication terminal 10 relative to the target object 30 is as follows: a) calculating a first time period between sending the electromagnetic wave signal with the specific frequency band the first time and receiving the electromagnetic wave signal with the specific frequency band the first time; b) calculating a first distance value between the mobile communication terminal 10 and the target object 30 when sending the electromagnetic wave signal with the specific frequency band the first time according to a transmission rate of the electromagnetic wave signal with the specific frequency band and the first time period; c) calculating a second time period between sending the electromagnetic wave signal with the specific frequency band for a second time and receiving the electromagnetic wave signal with the specific frequency band the second time; d) calculating the second distance value between the mobile communication terminal 10 and the target object 30 when sending the electromagnetic wave signal with the specific frequency band the second time according to the transmission rate of the electromagnetic wave signal with the specific frequency band and the second time period; e) calculating a third time period between sending the electromagnetic wave signal with the specific frequency band a first time and sending the electromagnetic wave signal with the specific frequency band the second time; f) calculating the difference value between the first distance value and the second distance value, and calculating the speed of the mobile communication terminal 10 relative to the target object 30 according to the third time period and the difference value.

In step S305, the output module 1203 outputs the result of the calculating module 1202 by a display or a speaker.

The method above, allows the mobile communication terminal 10 to sense distance value between the mobile communication terminal 10 and target object 30 and speed value of the mobile communication terminal 10 relative to the target object 30.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A mobile communication terminal with distance and speed sensing function, comprising:
a processing unit;
an antenna;
a decoding/encoding unit, to encode signals sent by the processing unit, generate encoded electromagnetic wave signals having a specific frequency band, decode electromagnetic wave signals having the specific frequency band received by an antenna, and send the decoded received electromagnetic wave signals to the processing unit; and the antenna to transmit the encoded electromagnetic wave signals having the specific frequency band to other mobile communication terminals and receive electromagnetic wave signals having the specific frequency band sent by the other communication terminals;
a wave guide pipe, to transmit the encoded electromagnetic wave signals having the specific frequency band to a target object and receive electromagnetic wave signals having the specific frequency band reflected by the target object;
an input unit, to receive inputs from a user, generate an activating signal to the processing unit to activate the distance and speed sensing function; and
a switching unit, connects the decoding/encoding unit to the wave guide pipe;
wherein the processing unit comprises:
a control module, to receive the activating signal sent by the input unit, control the switching unit to connect the processing unit to the wave guide pipe, and send the activating signal to the encoding/decoding unit, wherein the encoding/decoding unit generates an encoded electromagnetic wave signal having the specific frequency band according to the activating signal, the wave guide pipe transmits the encoded electromagnetic wave signals having the specific frequency band to a target object and receive the electromagnetic wave signal having the specific frequency band reflected by the target object;
a calculating module, to calculate the distance value between the mobile communication terminal and the target object and speed value of the mobile communication terminal relative to the target object; and
an output module, to output a result of the calculating module.

2. The mobile communication terminal according to claim 1, wherein the calculating module calculates a first time period between sending the electromagnetic wave signal with the specific frequency band for the first time and receiving the electromagnetic wave signal with the specific frequency band for the first time, calculates a first distance value between the mobile communication terminal and the target object when sending the electromagnetic wave signal with the specific frequency band for the first time according to a transmission rate of the electromagnetic wave signal with the specific frequency band and the first time period; calculates a second time period between sending the electromagnetic wave signal with the specific frequency band for a second time and receiving the electromagnetic wave signal with the specific frequency band for the second time, calculates the second distance value between the mobile communication terminal and the target object when sending the electromagnetic wave signal with the specific frequency band for the second time according to the transmission rate of the electromagnetic wave signal with the specific frequency band and the second time period, calculates a third time period between sending the electromagnetic wave signal with the specific frequency band for a first time and sending the electromagnetic wave signal with the specific frequency band for the second time; calculates difference value between the first distance value and the second distance value; and calculates the speed of the mobile communication terminal relative to the target object according to the third time period and the difference value.

3. The mobile communication terminal according to claim 1, wherein the switching unit automatically connects the decoding/encoding unit to the antenna when a predetermined time period is expired after receiving the activating signal.

4. The mobile communication terminal according to claim 1, wherein the switching unit is a double-throw switch.

5. The mobile communication terminal according to claim 1, wherein the specific frequency band is 900/1800 or 2400 MHZ.

6. The mobile communication terminal according to claim 1, wherein the output module outputs the result of the calculating module by a display or a speaker.

7. A method for sensing distance between the mobile communication terminal and a target object and speed value of the mobile communication terminal relative to the target object, the mobile communication terminal comprising a processing unit, a decoding/encoding unit, a wave guide pipe, an input unit and a switching unit, the method comprising:
receiving an activating signal generated by the input unit;
controlling the switching unit to connect the encoding/decoding unit to the wave guide pipe;
sending the activating signal to the encoding/decoding unit;
generating an encoded electromagnetic wave signal having the specific frequency band according to the activating signal by the encoding/decoding unit;
transmitting the encoded electromagnetic wave signals having the specific frequency band to a target object and receiving the electromagnetic wave signal having the specific frequency band reflected by the target object by the wave guide pipe;
calculating the distance value between the mobile communication terminal and the target object and speed value of the mobile communication terminal relative to the target object; and
outputting a result of the calculating.

8. The method according to claim 7, wherein the step of calculating the distance value between the mobile communication terminal and the target object and speed value of the mobile communication terminal relative to the target object further comprises: calculating a first time period between sending the electromagnetic wave signal with the specific frequency band for the first time and receiving the electromagnetic wave signal with the specific frequency band for the first time, calculating a first distance value between the mobile communication terminal and the target object when sending the electromagnetic wave signal with the specific frequency band for the first time according to a transmission rate of the electromagnetic wave signal with the specific frequency band and the first time period; calculating a second time period between sending the electromagnetic wave signal with the specific frequency band for a second time and receiving the electromagnetic wave signal with the specific frequency band for the second time, calculating the second distance value between the mobile communication terminal and the target object when sending the electromagnetic wave signal with the specific frequency band for the second time according to the transmission rate of the electromagnetic wave signal with the specific frequency band and the second time period, calculating a third time period between sending the electromagnetic wave signal with the specific frequency band for a first time and sending the electromagnetic wave signal with the specific frequency band for the second time; calculating difference value between the first distance value and the second distance value; and calculating the speed of the mobile communication terminal relative to the target object according to the third time period and the difference value.

9. The method according to claim 7, wherein the method further comprises: automatically connecting the decoding/encoding unit to an antenna when a predetermined time period is expired after receiving the activating signal.

10. The method according to claim 7, wherein the switching unit is a double-throw switch.

11. The method according to claim 7, wherein the specific frequency band is 900/1800 or 2400 MHZ.

12. The method according to claim 7, wherein the step of outputting a result of the calculating further comprises outputting the result of the calculating by a display or a speaker.
